(19) United States
(12) Patent Application Publication
(10) Pub. No.: US 2023/0252910 A1
(43) Pub. Date: Aug. 10, 2023

(54) METHODS AND SYSTEMS FOR ENHANCED TRAINING OF A USER

(71) Applicants: Davis Carbo, Marietta, GA (US); Gregory Carbo, Clearwater, FL (US)

(72) Inventors: Davis Carbo, Marietta, GA (US); Gregory Carbo, Clearwater, FL (US)

(21) Appl. No.: 18/304,193

(22) Filed: Apr. 20, 2023

(51) Int. Cl. G09B 19/00; G09B 5/06; G09B 5/04; G09B 5/02; G06V 20/40; G06V 40/20; G06V 10/94

(52) U.S. Cl. CPC G09B 19/003; G09B 5/065; G09B 5/04; G09B 5/02; G06V 20/41; G06V 40/20; G06V 10/945

(57) ABSTRACT

This invention relates to a computerized training system, where training is administered on an electronic device connected to the network and to do the evaluation. The computerized environment intends to immerse students in an environment for interactive learning experience. Further, in this Platform, students go through the training, where verbal, non-verbal, or para-verbal communication as instructions are given, and then they have to upload a submission or response, performing the requested action, and then that submission is sent to reviewer. Reviewer reviews the response and provides grades and feedback through the use of “tags”, which tag their video with. Further, an artificial intelligence based system is trained to evaluate the number of videos and train the system according for artificial intelligence based evaluation and grading. An augmented reality (AR) or virtual reality (VR) environment is provided to the user, wherein AR/VR environment containing a plurality of virtual elements.

### TECHNICAL FIELD

Embodiments of the present invention are in the field of training, and pertain particularly to methods and systems for providing performance training with an electronic device.

### BACKGROUND

Interactive learning is a pedagogical approach that incorporates social networking and urban computing into course design and delivery. Interactive learning has evolved out of the hyper-growth in the use of digital technology and virtual communication, particularly by students. The use of digital media in education has led to an increase in the use of and reliance on interactive learning, which in turn has led to a revolution in the fundamental process of education.

Increasingly, students and teachers rely on each other to access sources of knowledge and share their information, expanding the general scope of the educational process to include not just instruction, but the expansion of knowledge. The role change from keeper of knowledge to facilitator of learning presents a challenge and an opportunity for educators to dramatically, change the way their students learn. The boundaries between teacher and student have less meaning with interactive learning.

Methods of teaching and learning use a multi-sensory approach where students/user physically moves as they practice and learn the relationships of words, numbers, or any abstract concept. In some embodiments, methods include physical activity and imagination while practicing. In some embodiments, activity mats allow students to physically move as they learn the relationships of abstract concepts thus using more learning modalities (visual, auditory, motor, and kinesthetic) when practicing. Methods result in enthusiasm for the task of learning and practicing the abstract concept. Enthusiasm for the task leads to greater willingness to practice over and over again, thus leading to competence in learning, often at a younger age than conventionally expected.

### SUMMARY OF THE INVENTION

Embodiments of the present invention are in the field of training, and pertain particularly to methods and systems for providing performance training with an electronic device, the electronic device having one or more cameras for capturing the video.

This invention relates to computerized training systems, and more particularly computerized training systems where the training is administered on an electronic device such as computer system, mobile device or other computing devices, which are connected to the network to perform training and training evaluations. The preferable environment is a computerized system with associated devices that immerse students in emotionally engaging and functional operational environments throughout the interactive learning experience.

Aspects of the present invention discloses a system and a method that provides an online training platform where users can access educational tools and content that include but are not limited to written content, quizzes, flashcards, etc. Further, within this methodology, as users progress they are presented with a scenario whether that be verbal, written, or video presented in an augmented reality or virtual reality, and are tasked with responding to the scenario before being able to continue forward. Their response is sent to a reviewer that then grades/judges their nonverbal, verbal, and para-verbal response and gives the user feedback through the use of video, written word, audio, and “tags” that tag users video with descriptive words and phrases.

The user can access the training platform, can get enrolled themselves into the course, and one can check it.

Further, an artificial intelligence based system is trained to evaluate the user submissions (video, verbal, or written), and train the system accordingly for artificial intelligence to grade the users nonverbal, para-verbal, and verbal communication.

The implemented method, where the display presents an augmented reality or virtual reality (“AR/VR”) environment for a user, the AR/VR environment containing a plurality of virtual elements. The user submissions can also utilizing the virtual elements and submitting video in the AR/VR environment.

The summary of the invention does not necessarily disclose all the features essential for defining the invention. The invention may reside in a sub-combination of the disclosed features. The various combination and sub combination are fully described in the detailed description.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates a flowchart of a computer implemented method for facilitating training to a user, in accordance with a preferred embodiment of the invention.

FIG. 2 illustrates a system for facilitating training to a user, in accordance with a preferred embodiment of the invention.

FIG. 3 shows a perspective view of an implementation of an example device to provide a VR environment according to some embodiments, in accordance with a preferred embodiment of the invention.

FIGS. 4A-4I shows a screenshot of the website/platform implementing the present invention, in accordance with a preferred embodiment of the invention.

### DETAILED DESCRIPTION OF DRAWINGS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

In the following description, numerous specific details are set forth in order to provide a thorough understanding of embodiments of the present invention. It will be apparent to one skilled in the art that embodiments of the present invention may be practiced without some of these specific details.

Various terms as used herein are shown below. To the extent a term used, it should be given the broadest definition persons in the pertinent art have given that term as reflected in printed publications and issued patents at the time of filing.

The present invention implements an electronic device based, AI-based computer vision techniques, to analyze user movements, generate user analytics and feedback, and facilitate interactive virtual coaching and training.

The embodiments of the present invention allow users to perform real-time or delayed monitoring, analysis and interactive training with an electronic device by utilizing simple on-device cameras and general-purpose processors.

Innovative and efficient object detection of Non-Verbal, para-verbal, and verbal communication techniques enable the analysis of images or video recordings, vocal submissions, or other modes of submitted data captured by one or more on-device cameras to determine user analytics including movement patterns, body postures, eye tracking detection, vocal pitch tracking, speed of speech tracking, and optionally other any non-human objects such as balls or doors present in the training area.

In various embodiments, computer vision techniques such as image registration, motion detection, background subtraction, objection tracking, 3D-reconstruction techniques, cluster analysis techniques, camera calibration techniques such as camera pose estimation and sensor fusion, and modern machine learning techniques such as convolutional neural network (CNN), may be selectively combined to perform high accuracy analysis in real-time or delayed on the electronic device.

The virtual coaching and performance training process is the simulation of external stimuli and the facilitation of user response or interaction through a user interface to complete some aspects of the training. An in-person partner or coach can provide instructions for a next set of drills or instructions, and often serves as an assistant in clocking time, providing targets and challenges, and giving changing orders at random time instances to train a user's reaction time. Embodiments of the present invention can simulate such external stimuli and track the user's physical reactions in response through a mobile application having computer readable instructions stored in the memory of the electronic device. These computer readable instructions are processed by a general purpose processor. That is, while the process of capturing a training video is passive without explicit user inputs, interactive virtual coaching and performance training involve active user interaction with an augmented or completely virtual environment, through particular non-verbal, para verbal, or verbal sequences and/or audio inputs, but without the use of wearable sensors or controls. For example, a user or user may be required to jump to a certain height for a given number of times to achieve a training goal. The desired height may be simulated as a virtual target line superimposed onto the training video, and interactivity may derive from the user trying to virtually touch the line with his hand or top of his head in the image plane of the training video.

It may be appreciated that the present invention is implemented using various computing devices and electronic devices connected to each other over the internet or in a distributed network manner.

For example, an electronic device for implementing a training system is operated by a user that includes one or more components (processors, memory user interfaces/displays). As will be recognized, these architectures and descriptions are provided for exemplary purposes only and are not limited to the various embodiments.

In general, the terms device, system, computing device, electronic device, entity and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, retrieving, operating on, processing, displaying, storing, determining, creating, generating, generating for display, monitoring, evaluating, comparing, and/or similar terms used herein interchangeably. In various embodiments, these functions, operations, and/or processes can be performed on data, content, information, and/or similar terms used herein interchangeably. Furthermore, in embodiments of the present invention, computing device may be a mobile device, and may be operated by a user participating in an interactive physical training activity.

In an exemplary embodiment, the computing or electronic entity/device may include an antenna, a radio transceiver, and a processing unit that provides signals to and receives signals from the transceiver. The signals provided to and received from the transceiver may include signaling information in accordance with air interface standards of applicable wireless systems. In this regard, the computing entity may be capable of operating with one or more air interface standards, communication protocols, modulation types, and access types. More particularly, the user computing entity may operate in accordance with any of a number of wireless communication standards and protocols. In some embodiments, computing entity may operate in accordance with multiple wireless communication standards and protocols, such as 5G, UMTS, FDM, OFDM, TDM, TDMA, E-TDMA, GPRS, extended GPRS, CDMA, CDMA2000, 1×RTT, WCDMA, TD-SCDMA, GSM, LTE, LTE advanced, EDGE, E-UTRAN, EVDO, HSPA, HSDPA, MDM, DMT, Wi-Fi, Wi-Fi Direct, WiMAX, UWB, IR, NFC, ZigBee, Wibree, Bluetooth, and/or the like.

Similarly, the computing or electronic entity may operate in accordance with multiple wired communication standards and protocols, via a network and communication interface.

Via these communication standards and protocols, the computing entity can communicate with various other computing entities using concepts such as Unstructured Supplementary Service Data (USSD), Short Message Service (SMS), Multimedia Messaging Service (MIMS), Dual-Tone Multi-Frequency Signaling (DTMF), and/or Subscriber Identity Module Dialer (SIM dialer). The computing entity can also download changes, add-ons, and updates, for instance, to its firmware, software (e.g., including executable instructions, applications, program modules), and operating system.

In some implementations, processing unit/processor may be embodied in several different ways. For example, processing unit may be embodied as one or more complex programmable logic devices (CPLDs), microprocessors, multi-core processors, co processing entities, application-specific instruction-set processors (ASIPs), microcontrollers, and/or controllers. Further, the processing unit may be embodied as one or more other processing devices or circuitry. The term circuitry may refer to an entirely hardware embodiment or a combination of hardware and computer program products. Thus, processing unit may be embodied as integrated circuits, application specific integrated circuits (ASICs), field programmable gate arrays (FPGAs), programmable logic arrays (PLAs), hardware accelerators, other circuitry, and/or the like. As will therefore be understood, processing unit may be configured for a particular use or configured to execute instructions stored in volatile or non-volatile media or otherwise accessible to the processing unit. As such, whether configured by hardware or computer program products, or by a combination thereof, processing unit may be capable of performing steps or operations according to embodiments of the present invention when configured accordingly.

In some embodiments, processing unit/processor may comprise a control unit and a dedicated arithmetic logic unit (ALU) to perform arithmetic and logic operations. In some embodiments, user computing entity may optionally comprise a graphics processing unit (GPU) for specialized image and video rendering tasks, and/or an artificial intelligence (AI) accelerator, specialized for applications including artificial neural networks, machine vision, and machine learning. In some embodiments, processing unit may be coupled with GPU and/or AI accelerator to distribute and coordinate processing tasks.

In some embodiments, computing entity/device may include a user interface, comprising an input interface/display and an output interface, each coupled to processing unit. User input interface may comprise any of a number of devices or interfaces allowing the user computing entity to receive data, such as a keypad (hard or soft), a touch display, a microphone for voice/speech, and a camera for motion or posture interfaces. User output interface may comprise any of a number of devices or interfaces allowing user computing entity to provide information to a user, such as through the touch display, or a speaker for audio outputs. In some embodiments, output interface may connect user computing entity to an external loudspeaker or projector, for audio or visual output.

User computing entity/device may also include volatile and/or non-volatile storage or memory, which can be embedded and/or may be removable. A non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory may store an operating system, application software, data, databases, database instances, database management systems, programs, program modules, scripts, source code, object code, byte code, compiled code, interpreted code, machine code, executable instructions, and/or the like to implement the functions of user computing entity.

As indicated, this may include a user application that is resident on the entity or accessible through a browser or other user interface for communicating with a management computing entity and/or various other computing entities.

In some embodiments, a gesture sensor can be utilized for capturing the gestures of the users as part of the training.

In some embodiments, user computing entity/device may include location determining aspects, devices, modules, functionalities, and/or similar words used herein interchangeably. For example, user computing entity may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites.

Alternatively, the location information may be determined by triangulating the user computing entity's position in connection with a variety of other systems, including cellular towers, Wi-Fi access points, and/or the like.

Similarly, user computing entity may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

In some embodiments, a system for virtual coaching and performance training may include at least one user computing or electronic device such as a mobile computing device and optionally a mounting apparatus for the at least one mobile computing device. The mounting apparatus may be a tripod or a kickstand, and may mount the electronic device with a camera of the user computing device positioned to monitor a training area. In some embodiments, the user computing device may be hand-held or put on the ground leaning against certain articles such as a water bottle.

In some embodiments, the system for virtual coaching and performance training further comprises a sound device, for example, earbuds (e.g., wireless earbuds) or a speaker system (e.g., a public address (PA) system) coupled to the at least one user computing device. The sound device may serve to provide instruction and feedback regarding the training session to the user. In some embodiments, the system optionally comprises an optical device such as a projector, a projection lamp, a laser pointing system, a jumbotron, a television screen, or the like, that can facilitate an interactive training session. For example, a laser pointing system may point to a location in the training area to direct the user to position himself or herself, or it may point to a location in a display of the training video as the visual cue, to direct the user to perform a desired set of physical movements.

In some embodiments, user computing entity/device may communicate to external devices like other smartphones and/or access points to receive information such as software or firmware, or to send information (e.g., training data such as analytics, statistics, scores, recorded video, etc.) from the memory of the user computing device to external systems or devices such as servers, computers, smartphones, and the like.

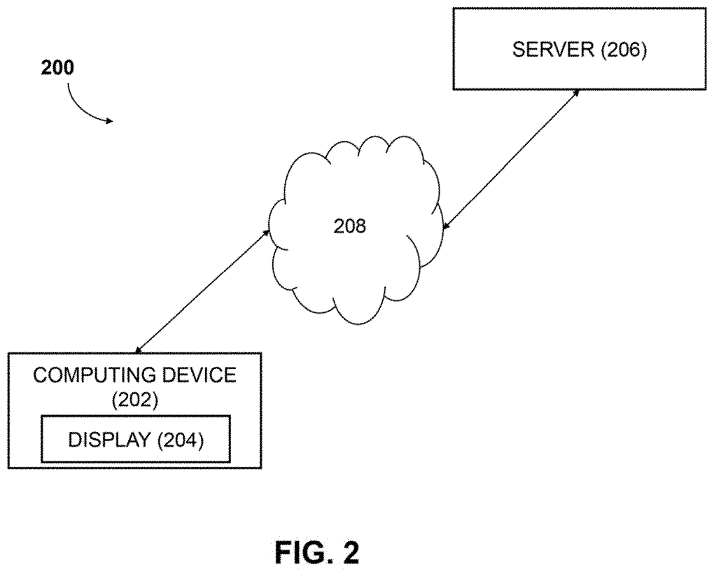

In some embodiments, data such as training statistics, scores, and videos may be uploaded by one or more user computing devices to a server such as shown in FIG. 2, when the device accesses a network connection, such as a wireless access point or hotspot.

The data transfer may be performed using protocols like file transfer protocol (FTP), MQ telemetry transport (MQTT), advanced message queuing protocol (AMQP), hypertext transfer protocol (HTTP), ad HTTP secure (HTTPS). These protocols may be made secure over transport layer security (TLS) and/or secure sockets layer (SSL).

In some embodiments, audio generated by a user computing device and/or audio generated by one or more users may be used to facilitate an interactive training session. In some embodiments, audio may be used to (i) direct users to particular positions on training areas (with further audio feedback to help the users locate themselves more accurately), (ii) inform users about a motion or action that a user needs to do as part of the training (e.g., shoot a ball at a basket, perform a back flip, perform an exercise such as pushups, and the like), (iii) provide feedback to the user (e.g., to inform them if the users are making a wrong move, running out of time, have successfully completed a given drill, or achieved a particular score), or (iv) report on the progress of the training session (statistics, leaderboard, and the like). In some embodiments, speech recognition and corresponding responses (e.g., audio, visual, textual, etc. responses) may also be used to facilitate the training session by allowing users to set options, correct mistakes, or start or stop the training session.

In some embodiments, artificial intelligence-based computer vision algorithms may be used to perform at least one of the following: (i) ensure that users are located where they should be, (ii) determine when/if users successfully complete a task, (iii) rank the quality of users' motion/action, and (iv) award quality points or other attributes depending on the nature of the users' motion.

In various embodiments, during the physical activities performed by users, the mobile computing device may not be on the user's body or hand and instructions may be given via a speaker or other remote devices connected to the mobile device. Further, computer vision algorithms may be used on the mobile device to guide and monitor training being conducted within the mobile device camera's field of view. Accordingly, embodiments of devices described herein can employ artificial intelligence (AI) on the server or cloud to facilitate automating one or more training features of functionalities as described herein.

To provide for or aid in the numerous determinations (e.g., determine, ascertain, infer, calculate, predict, prognose, estimate, derive, forecast, detect, compute) of training settings, user postures and user analytics described herein, components described herein may examine the entirety or a subset of data to which it is granted access and can provide for reasoning about or determine states of the system or environment from a set of observations as captured via events and/or data. Determinations may be employed to identify a specific context or action, or may generate a probability distribution over states, for example. The determinations may be probabilistic. That is, the computation of a probability distribution over states of interest based on a consideration of data and events. Determinations may also refer to techniques employed for composing higher-level events from a set of events and/or data.

Such determinations may result in the construction of new events or actions from a set of observed events and/or stored event data, whether the events are correlated in close temporal proximity, and whether the events and data come from one or several event and data sources. For example, training instructions and feedbacks to user may be generated from one or more user analytics derived from user training actions. Further, components disclosed herein may employ various classification schemes (e.g., explicitly trained via training data or implicitly trained via observing behavior, preferences, historical information, receiving extrinsic information, etc.) and/or systems (e.g., support vector machines, neural networks, expert systems, Bayesian belief networks, fuzzy logic, data fusion engines, etc.) in connection with performing automatic and/or determined action in connection with the claimed subject matter.

Thus, classification schemes and/or systems may be used to automatically learn and perform a number of functions, actions, and/or determinations.

A computer implemented method for facilitating training using an electronic device, having a camera with audio and visual input, the method comprising by capturing a written, verbal, audio, or video response of a user using the camera on the electronic device, wherein the response comprises of the user performing an activity or prerequisite based on one or more training tasks presented during the training on a display of the electronic device; determining whether the user is performing the activity in the video by analyzing the verbal, non-verbal, or para-verbal communication of the user. between a first-time instance and a second-time instance, the first-time instance is a time instance triggered at a start when the video capturing begins; transmitting, in response to determining if the user is correctly performing the activity, the video to at least one server to perform evaluation; and generating custom feedback to the user based on the activity and the evaluation performed.

In a preferred embodiment, the training methodology uses AR (Augmented Reality) or VR (Virtual Reality) capabilities. Different scenarios are discussed for the better understanding of the invention.

Scenario 1: AR and VR capabilities added to video segment for users/student:
User/Student is presented with a video requirement portion of the training.
The user is presented with a scenario or situation within AR or VR.
The user must respond to the scenario before being able to move on to the next portion of the lesson utilizing the plurality of virtual elements in the AR or VR mode in their submission.

Scenario 2: AR and VR capabilities added to video segment for reviewers, admins, trainers:
Reviewers, admins, and trainers are presented with a student/user's video requirement portion of the training for evaluation.
They are presented with a scenario or situation within AR augmented reality or VR virtual reality.
They must respond to the scenario and leave a grade or other evaluation using AR or VR capabilities of the system.

Scenario 3: Training platform is built into VR or AR program:
A user/student enters the training platform either in augmented reality or virtual reality mode.
Within the platform user/student is presented with a scenario or prompt that they must complete before moving forward.
Student/user must respond in the AR or VR environment.

Scenario 4: Training analysis of user/student submitted video is conducted in AR or VR:
Reviewers, admins, and trainers enter the platform in augmented reality or virtual reality.
They are presented with a submitted VR AR component for evaluation.
They must respond to the scenario and leave a grade or other evaluation using AR or VR capabilities of the system.

In an exemplary embodiment, the one or more training tasks are user specific and generated in real-time based on age, gender, sex, and one or more historical training data of the user.

In an exemplary embodiment, the activity of the user is analyzed by performing a computer vision algorithm on one or more frames of the captured video.

Now the invention would be explained with the help of drawings/illustrations:

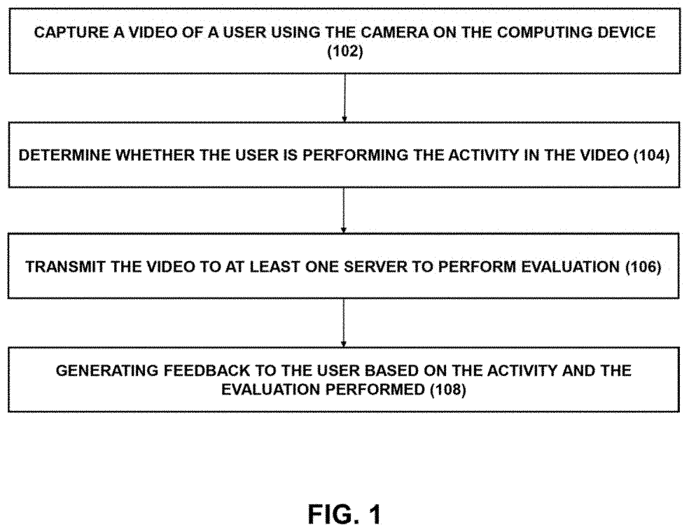

FIG. 1 illustrates a flowchart of a computer implemented method for facilitating training to a user, in accordance with a preferred embodiment of the invention.

In an implementation of the embodiment, the present invention provides computer implemented method for facilitating training using a computing device having a camera.

At step 102, a video of a user is captured by using the camera on the computing device. The video captures the user performing an activity based on one or more training tasks presented on a display of the computing device.

At step 104, it is determined whether the user is performing the activity in the video by analyzing the activity of the user between a first-time instance and a second-time instance.

The first-time instance is a time instance triggered at a start when the video capturing begins.

At step 106, in response to determining if the user is performing the activity, the video is transmitted to at least one server to perform evaluation.

At step 108, feedback is generated to the user based on the activity and the evaluation performed. In an exemplary embodiment, the feedback is generated in a form of written word or tags or recommendations. In another exemplary embodiment, the feedback is generated by one or more users reviewing the received video at the at least one server.

In an exemplary embodiment, the feedback is tagged along with the video such that the tagged video is presented to the user after generating custom or generic feedback.

In an exemplary embodiment, the method can further include the step of prohibiting access to view feedback of one or more videos generated for other users until the video of the user is not transmitted to the at least one server for evaluation or completely transmitted to the at least one server for evaluation.

In an exemplary embodiment, the method can further include the step of re-capturing the video of the user performing the activity if the user is determined not performing the activity.

In an exemplary embodiment, the method can further include the step of re-capturing the video of the user performing the activity if the user is determined not performing the activity.

In an exemplary embodiment, the computing device is a wearable computing device and the display to provide an augmented reality or virtual reality (“AR/VR”) environment for the user, the AR/VR environment containing virtual elements. The wearable computing device includes a bio-signal sensor. The bio-signal sensor receives bio-signal data from the user. The bio-signal sensor includes a brainwave sensor.

In various embodiments, the following additional implementation possibilities are contemplated to be within the scope of the present invention. These exemplary embodiments are for illustrative purposes only and do not limit the scope of the present invention.

(1) A training system that facilitates training sessions to monitor cross-over style movements during the task (for example the game of basketball).

(2) A training system which facilitates training sessions that incorporate various dribble challenges, for example to dribble uninterrupted for a number of times, to dribble with one hand only while keeping the other hand fixed, to dribble with one hand in a particular pattern such as around a shape of figure “8”, or to switch among different dribbling types including front dribble, behind-the-back dribble, under-the-leg dribble and the like.

(3) A training system that allows a training video to be sent via a communications interface to a viewing medium, such as Airplay to an Apple TV.

(4) A training system places the user in an augmented reality (AR) environment, possibly using additional equipment such as head mounted displays and/or projection lamps integrated into the system. For example, instead of editing or annotating a recorded training video file or stream, a projection lamp coupled to the mobile computing device may be used to project a visual cue onto a projection of the training video, as an augmentation of the training video. The training video may be analyzed while taking into consideration of the projected visual cue, to determine user posture flows and user responses. In another example, in addition to recording the user and the training environment as the training video, additional virtual elements may be generated, optionally based on captured user inputs, and the training video may be partially or fully virtualized to place the user in an AR or virtual reality (VR) environment.

Systems, methods, and apparatuses that provide analysis and real-time and/or near real-time correction of movement patterns and postures of users during training sessions. As discussed previously, visual or audio feedback information in the form of textual messages and graphical symbols may be given to the user as the system analyzes the user's posture flow.

FIG. 2 illustrates system for facilitating training to a user, in accordance with a preferred embodiment of the invention. In an embodiment, a system for facilitating training to a user is disclosed.

The system includes a computing or electronic device having a camera. The computing device is in communication with a processor configured to capture a video of a user using the camera on the computing device that includes the user performing an activity based on one or more training tasks presented on a display of the computing device, determine whether the user is performing the activity in the video by analyzing the activity of the user between a first-time instance (the first-time instance is a time instance triggered at a start when the video capturing begins) and a second-time instance, transmit the video to at least one server to perform evaluation in response to determining if the user is performing the activity, and generate feedback to the user based on the activity and the evaluation performed.

In an exemplary embodiment, the computing device is a wearable computing device with a bio-signal sensor and the display to provide an augmented reality or virtual reality (“AR/VR”) environment for the user, the AR/VR environment containing virtual elements; the bio-signal sensor receives bio-signal data from the user, the bio-signal sensor comprising a brainwave sensor.

In an exemplary embodiment, the one or more training tasks are presented in a form of a video instruction, an audio instruction or audio-video instructions.

In an exemplary embodiment, the one or more training tasks are user specific and generated in real-time based on age, gender, sex, and one or more historical training data of the user. In an exemplary embodiment, the activity of the user is analyzed by performing a computer vision algorithm on one or more frames of the captured video.

In an exemplary embodiment, the feedback is generated in a form of written word or tags or recommendations; and the feedback is tagged along with the video such that the tagged video is presented to the user after generating feedback.

In an exemplary embodiment, the processor prohibits access to view feedback of one or more videos generated for other users until the video of the user is not transmitted to the at least one server for evaluation.

In an exemplary embodiment, the processor re-captures the video of the user performing the activity: if the user is determined not performing the activity or based on a trigger generated by the user.

In an exemplary embodiment, the feedback is generated by one or more users reviewing the received video at the at least one server.

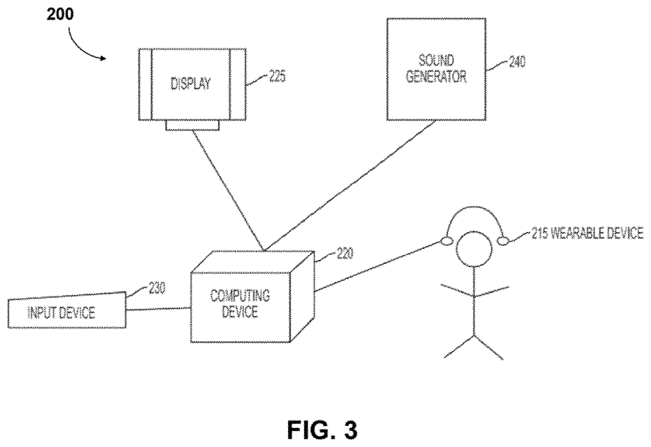

FIG. 3 shows a perspective view of an implementation of an example device to provide a VR environment according to some embodiments, in accordance with a preferred embodiment of the invention.

Referring to FIG. 3 in accordance with another implementation of embodiments described herein, there is provided a perspective view of a training system 200 with a display 225; Input devices 230; sound generator 240; a wearable device 215; and computing device 220. The wearable device 215 has a headset with bio-signal sensors, facial bio-signal sensors and tracker modules with the functionality of corresponding to the bio-signal sensors (not shown), the facial bio-signal sensors, and a tracker. The display 225 having the functionality of the stereoscopic display. The Input devices 230 and sound generator 240 similarly having the functionality of the input devices and sound generator 240.

The VR environment generated by the other implementation of FIG. 3 may provide an adequate interactive VR environment to facilitate training.

In an example, a training system with a wearable device and other computing device can be implemented as an exemplary embodiment. The wearable device may include a stereoscopic display; bio-signal sensors; facial bio-signal sensors; sound generator; a computing device; tracker; and user manual inputs such as mouse, joystick, or keyboard (not shown). The other computing device and the computing device may be, for example, a computer, embedded computer, server, laptop, tablet, or mobile phone. The stereoscopic display is a 3-dimensional (3D) (or dual 2-dimensional (2D) images giving “3D”) display, but alternatively may be a 2-dimensional (2D) display.

The other computing device is in communication with the wearable device and provides the wearable device with content to create a VR (Virtual Reality) environment The VR environment includes an interactive VR environment where content presented on the display may update or modify in response to input from bio-signal sensors, other sensors user manual inputs, or other inputs, for example. The other computing device may also be a server over the Internet or other network. In other embodiments, the functions of the other computing device are incorporated into the computing device. In further embodiments, the functions of the computing device are incorporated into the other computing device.

The tracker can be an inertial sensor for measuring movement of the wearable device. It detects the 3-dimensional coordinates of the wearable device and accordingly its user's location, orientation or movement in the VR environment including the user's gaze direction. The tracker, for example, comprises one or more accelerometers and/or gyroscopes. The sound generator, for example, comprises one or more speakers, microphones, and/or head phones.

In various implementations, the wearable device may include a variety of other sensors, input devices, and output devices. For example, the wearable device may comprise touch sensor for receiving touch input from the user and tactile device for providing vibrational and force feedback to the user. The training system may further include input devices that include but not limited to a mouse, keyboard and joystick.

The wearable device is, for example, a wearable headset worn on a user's head. The computing device of the wearable device is configured to create a VR environment on the stereoscopic display and sound generator for presentation to a user; receive bio-signal data of the user from the bio-signal sensors, at least one of the bio-signal sensors comprising a brainwave sensor, and the received bio-signal data comprising at least brainwave data of the user; and determine brain state response elicited by the VR environment at least partly by determining a correspondence between the brainwave data and a predefined bio-signal measurement stored in a user profile, the predefined bio-signal measurement associated with predefined brain state response type. The brain state response may comprise an emotional response type. The wearable device may be called a virtual reality headset.

The VR (stereoscopic) display is positioned for viewing through an eye mask wearable by a user. The eye mask comprises an aperture for each eye, and a plurality of facial bio-signal sensors positioned on the mask for contacting the user's face when the wearable device is worn. One or more straps, which may optionally be adjustable, are attached to the eye mask or display portion of the wearable device. Optionally, bio-signal sensors may be positioned along one or more of the straps to sense brainwave activity in the user through the user's head. Sensors positioned along the straps may be specifically configured to travel a distance from the strap, past the user's hair, if any, to the user's scalp.

Accordingly, any such sensors may include an elongated contact area, which is optionally of a resilient construction. The facial bio-signal sensors measure, include, electrical bio-signals such as EEG, EMG (Electromyography) and EOG (Electrooculography), as well as FNIRS (functional near infrared spectroscopy). The materials used to support the device on the face may be opaque to the wavelengths used by the FNIRS sensors such that ambient light can be reduced and thus increase the signal to noise ratio for the sensor.

Electrical signals may be measured on other regions of the head and may be mounted to the supporting architecture of the display device. Typically these are elasticized fabric. Sensors that measure scalp potentials would typically have a fingered design to allow the conductive electrodes to reach through the hair to reach the surface of the scalp. The fingers should be springy to allow for comfort and allow for the user to manipulate them in a fashion that will spread and disperse hair to facilitate a low impedance interface to skin of the scalp. Capacitive electrodes may also be used. These would allow for a slight air between the electrode and the scalp. Many electrodes should be used if possible to allow for a higher dimensional bio-signal to facilitate denoising signal processing and to acquire more accurate spatial information of the bio-signal activity. Good spatial resolution will allow more precise interpretation of the electrical activity in the brain as well as muscular activity in the face and head—which are vital for accurate emotion estimation. Facial bio-signal sensors further yield facial expression information (which is difficult to obtain using cameras in a VR headset.). Muscles specifically around the eyes play an important role in conveying emotional state. Smiles for example if accompanied by engagement of the muscles at the corners of the eyes are interpreted as true smiles, as opposed to those that are put on voluntarily. EOG signals give information about eye movements. Basic gaze direction and dynamic movement can be estimated in real-time and can thus be used as a substitute for optical methods of eye tracking in many applications. Measurement of the EOG signal is also important for noise free interpretation of the EEG signal. FNIRS sensors if used can provide supplemental information about activity in the frontal region of the brain with high spatial accuracy. Other sensors tracking other types of eye movement may also be employed.

Embodiments of the training system may provide for the collection, analysis, and association of particular bio-signal and non-bio-signal data with specific brain states for both individual users and user groups. The collected data, analyzed data or functionality of the systems and methods may be shared with others, such as third party applications and other users. Connections between any of the computing devices, internal sensors (contained within the wearable device), external sensors (contained outside the wearable device), user effectors, and any servers may be encrypted. Collected and analyzed data may be used to build a user profile that is specific to a user. The user profile data may be analyzed, such as by machine learning algorithms, either individually or in the aggregate to function as a brain computer interface (BCD, or to improve the algorithms used in the analysis, Optionally, the data, analyzed results, and functionality associated with the system can be shared with third party applications and other organizations through an API. One or more user effectors may also be provided at the wearable device or other local computing device for providing feedback to the user, for example, to vibrate or provide some audio or visual indication to assist the user in achieving a particular mental state, such as a meditative state.

In another aspect of embodiments described herein, the wearable device may be in a form of one or more sensors adapted to being placed at or adhered to the user's head or face. Each sensor may optionally communicate with one another either through wires or wirelessly. Each sensor may optionally communicate with the other computing device either through wires or wirelessly. The other computing device may be mounted to the wearable device in order to reside at or near the user's head or face. Alternatively, the other computing device may be located elsewhere on the user's body, such as in a bag or pocket of the user's clothing or on a band or strap attachable to the user's body. The other computing device may also be disposed somewhere outside the user's body. For example, the sensors may monitor the user, storing data in local storage mounted to the wearable device, and once moving into proximity with the other computing device, the sensors, or a transmitter of the wearable device may transmit stored data to the other computing device for processing. In this implementation, the wearable device may be predominantly usable by the user when located nearby the other computing device.

Accordingly, the wearable device may implement a method that may involve acquiring bio-signal measurement from a user using the bio-signal measuring sensor during a VR event. The bio-signal measurement may include brainwave state measurement. The wearable device may process the bio-signal measurement, including at least the brainwave state measurement, in accordance with a profile associated with the user. The wearable device may determine a correspondence between the processed bio-signal measurement and predefined device control action, which may also generate effects in the VR environment. In accordance with the correspondence determination, the wearable device may control operation of component of the wearable device or effects in the VR environment, Various types of bio-signals, including brainwaves, may be measured and used to control the device or the VR environment in various ways. The controlling operation of component of the wearable device may comprise sharing the processed brainwave state measurement with computing device over a communications network. Thresholds of brain state may be learned from each user.

The wearable device may further be in communication with another computing device, such as a laptop, tablet, or mobile phone such that data sensed by the headset through the sensors may be communicated to the other computing device for processing at the computing device, or at one or more computer servers, or as input to the other computing device or to another computing device, The one or more computer servers may include local, remote, cloud based or software as a service platform (SAAS) servers. Embodiments of the system may provide for the collection, analysis, and association of particular bio-signal and non-bio-signal data with specific mental states for both individual users and user groups. The collected data, analyzed data or functionality of the systems and methods may be shared with others, such as third party applications and other users. Connections between any of the computing devices, internal sensors (contained within the wearable device), external sensors (contained outside the wearable device), user effectors (components used to trigger a user response), and any servers may be encrypted, Collected and analyzed data may be used to build a user profile that is specific to a user. The user profile data may be analyzed, such as by machine learning algorithms, either individually or in the aggregate to function as a brain computer interface or to improve the algorithms used in the analysis. Optionally, the data, analyzed results, and functionality associated with the system can be shared with third party applications and other organizations through an application programming interface (API). One or more user effectors may also be provided at the wearable device or other local computing device for providing feedback to the user, for example, to vibrate or provide some audio or visual indication in the VR environment to assist the user in achieving a particular mental state, such as a meditative state and provide training to the user.

Sensors usable with the wearable device may come in various shapes and be made of various materials. For example, the sensors may be made of a conductive material, including a conductive composite like rubber or conductive metal. The sensors may also be made of metal plated or coated materials such as stainless steel, silver-silver chloride, and other materials. The sensors include one or more bio-signal sensors, such as electroencephalogram (EEG) sensors, galvanometer sensors, electrocardiograph sensors, heart rate sensors, eye-tracking sensors, blood pressure sensors, pedometers, gyroscopes, and any other type of sensor. The sensors may be of various types, including: electrical bio-signal sensor in electrical contact with the user's skin; capacitive bio-signal sensor in capacitive contact with the user's skin; blood flow sensor measuring properties of the user's blood flow; and wireless communication sensor placed sub-dermally underneath the user's skin. Other sensor types may be possible.

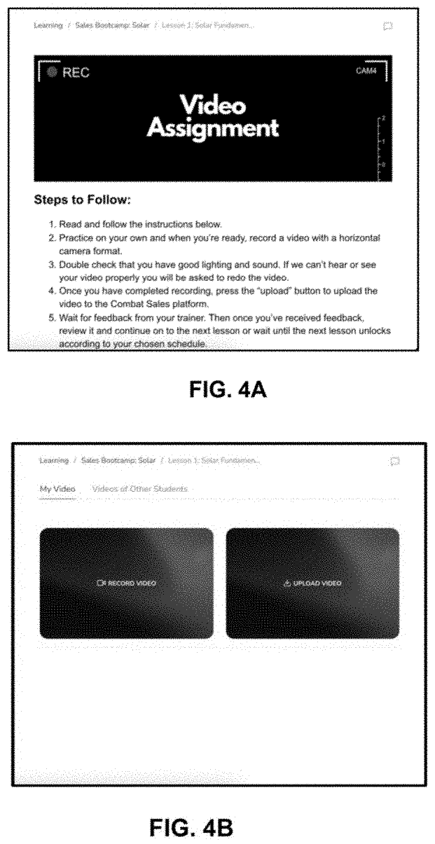

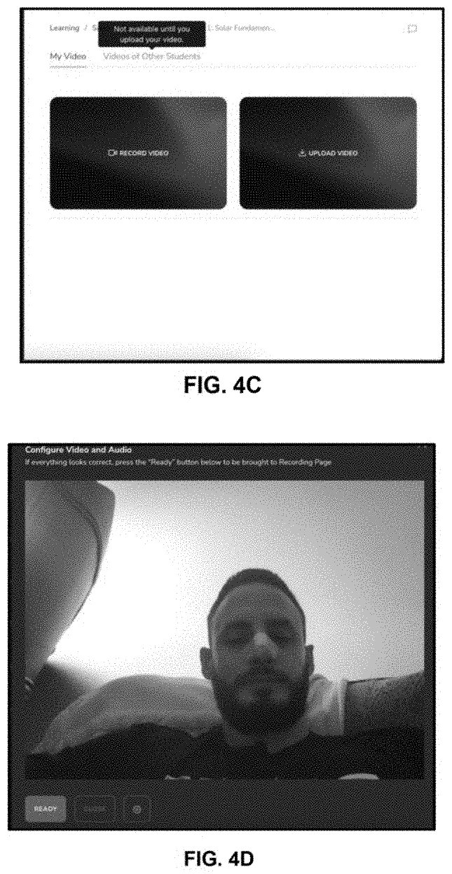

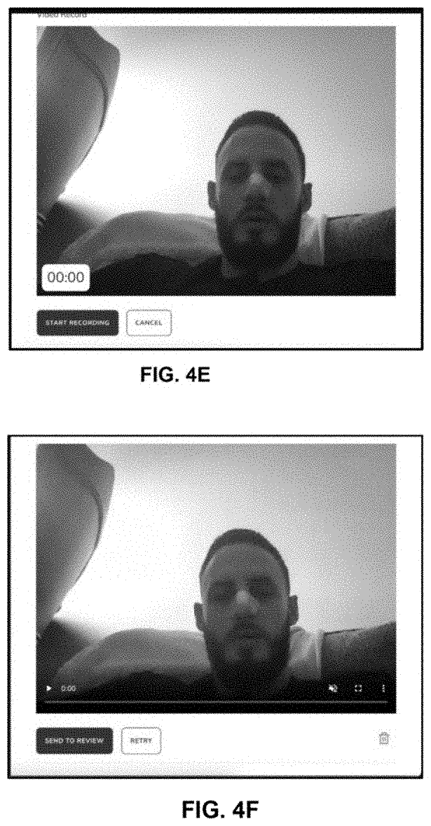

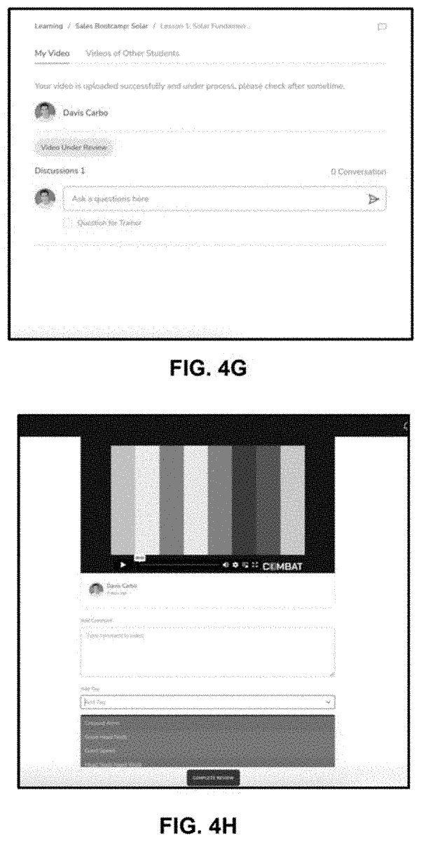

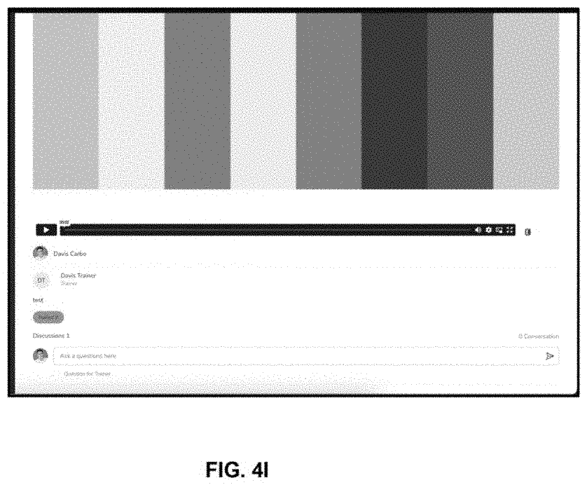

FIGS. 4A-4I shows screenshot of the website/platform implementing the present invention, in accordance with a preferred embodiment of the invention.

In an example, when students enter our platform they can access written content, quizzes, flashcards, etc. This is pretty standard with any training platform. What is unique to the platform of the present invention is that as students go through our training, we give them video instructions, and then they have to upload a video of themselves performing the requested action, and then that video gets sent back to us and we can grade their video and give them feedback through the use of written word and “tags” that we can tag their video with. A reviewer/trainer review videos submitted by students to give custom feedback and tag videos.

FIG. 4A shown a picture of the video assignment instructions. The system provides an option where they can record the video directly from their computer or upload one from their computer as shown in FIG. 4B. FIG. 4C shows that the user can block students from seeing others videos until they have successfully completed their own

FIGS. 4D and 4E shown the example of student recording the video. Once they are done, they can send to review or retry or review their video.

FIG. 4F shown what students see after they submit the video. The video is then sent to a “trainer” or a “reviewer” where we can review the video and submit feedback FIG. 4G-4I. shows the trainer can review the video, write feedback, and even add “tags” that get attached to the video. Then, the trainer can review the video, write feedback, and even add “tags” that get attached to the video.

While the subject invention is described and illustrated with respect to certain preferred and alternative embodiments, it should be understood that various modifications can be made to those embodiments without departing from the subject invention, the scope of which is defined in the following claims.

What is claimed is:

1. A computer implemented method for facilitating training using an electronic device, having a camera with audio and visual input, the method comprising:
capturing a written, verbal, audio, or video response of a user using the camera on the electronic device, wherein the response comprises of the user performing an activity or prerequisite based on one or more training tasks presented during the training on a display of the electronic device;
determining whether the user is performing the activity in the video by analyzing the verbal, non-verbal, or para-verbal communication of the user. between a first-time instance and a second-time instance, the first-time instance is a time instance triggered at a start when the video capturing begins;
transmitting, in response to determining if the user is correctly performing the activity, the video to at least one server to perform evaluation; and
generating custom feedback to the user based on the activity and the evaluation performed.

2. The computer implemented method of claim 1, wherein the display presents an augmented reality or virtual reality (“AR/VR”) environment for a user, the AR/VR environment containing a plurality of virtual elements.

3. The computer implemented method of claim 1, wherein the one or more training tasks are presented in a form of a video instruction, an audio instruction, written instruction or a combination of one or two instruction.

4. The computer implemented method of claim 1, wherein the one or more training tasks are user specific and generated in real-time based on a criteria that include but are not limited to age, gender, sex, and one or more historical training data of the user.

5. The computer implemented method of claim 1, wherein the activity of the user is analyzed by performing a computer vision algorithm on one or more frames of the captured video, analyzing the non-verbal, verbal, or para verbal communication of the user.

6. The computer implemented method of claim 1, wherein the feedback is generated in a form of written word or tags or recommendations.

7. The computer implemented method of claim 1, wherein the feedback is tagged along with the video such that the tagged video is presented to the user after generating feedback.

8. The computer implemented method of claim 1, wherein the method further comprising:
prohibiting access to view feedback of one or more videos generated for other users until the video of the user is completely transmitted to the at least one server for evaluation.

9. The computer implemented method of claim 1, wherein the method further comprising: re-capturing the video of the user performing the activity if the user is determined not performing the activity correctly or adequate.

10. The computer implemented method of claim 1, wherein the method further comprising: re-capturing the video of the user performing the activity based on a trigger generated by the user.

11. The computer implemented method of claim 1, wherein the feedback is generated by one or more reviewer reviewing the received video from one or more user at the at least one server.

12. The computer implemented method of claim 1, wherein the electronic device is configured to be a wearable computing device and connected to a display to provide an augmented reality or virtual reality (“AR/VR”) environment for the user, wherein the AR/VR environment containing virtual elements to interact with.

13. The computer implemented method of claim 12, wherein the wearable computing device comprises a bio-signal sensor; wherein the bio-signal sensor receives bio-signal data from the user.

14. The computer implemented method of claim 13, wherein the bio-signal sensor comprises a brainwave sensor.

15. A system for facilitating training to a user, wherein the system comprising:
an electronic device having a camera with audio and visual input, wherein the electronic device in communication with a processor configured to:
capture a written, verbal, audio, or video response of the user using the camera on the electronic device, wherein the video comprises of the user performing an activity based on one or more training tasks presented on a display of the electronic device;
determine whether the user is performing the assigned task by analyzing the verbal, non-verbal, or para-verbal communication of the user between a first-time instance and a second-time instance, the first-time instance is a time instance triggered at a start when the video capturing begins;
transmit, in response to determining if the user is performing the activity, the video to at least one server to perform evaluation; and
generate custom feedback to the user based on the activity and the evaluation performed.

16. The system of claim 15, wherein the electronic device is configured to be a wearable computing device having a bio-signal sensor and the display to provide an Augmented Reality (AR) or Virtual Reality (VR) environment for the user, wherein the AR/VR environment comprises a plurality of virtual elements, and the bio-signal sensor comprising a brainwave sensor, receives bio-signal data from the user.

17. The system of claim 15, wherein:
the one or more training tasks are presented in a form of a written, verbal, audio, or video instruction, and the one or more training tasks are user specific and generated in real-time based on age, gender, sex, and one or more historical training data of the user; and
the activity of the user is analyzed by performing a computer algorithm on one or more frames of the captured video.

18. The system of claim 15, wherein the feedback is generated in a form of customized written word or tags or recommendations; and the feedback is tagged along with the video such that the tagged video is presented to the user after generating feedback.

19. The system of claim 15, wherein the processor is configured to:
prohibit access to view feedback of one or more videos generated for other users until the submission of the user is completely transmitted to the at least one server for evaluation; and re-captures the video of the user performing the activity, if the user is determined not performing the activity or based on a trigger generated by the user.

20. The system of claim 15, wherein the feedback is generated by one or more reviewer, reviewing the received response or submission at the at least one server.
